(19) United States
(12) Patent Application Publication
(10) Pub. No.: US 2023/0321663 A1
(43) Pub. Date: Oct. 12, 2023

(54) HYDROCARBON DISTILLATION

(71) Applicant: Saudi Arabian Oil Company, Dhahran (SA)

(72) Inventors: Maha Nour, Thuwal (SA); Amjad Felemban, Thuwal (SA); Hamad Al Saiari, Al-Khobar (SA)

(21) Appl. No.: 17/717,804

(22) Filed: Apr. 11, 2022

(51) Int. Cl. B01L 7/00

(52) U.S. Cl. CPC B01L 7/525; B01L 2300/0883; B01L 2300/1827; B01L 2300/087; B01L 2300/0896; B01L 2200/12; B01L 2300/0809; B01L 2300/12

(57) ABSTRACT

An apparatus includes a plate and a microheater. The plate defines a sample reservoir, component reservoirs, an outlet, a microfluidic channel, and branches. The sample reservoir is configured to hold a specified sample volume of a hydrocarbon sample. Each component reservoir is configured to hold a respective specified component volume of a different one of the hydrocarbons. The microfluidic channel extends from the sample reservoir to the outlet. Each branch connects a different one of the component reservoirs to the microfluidic channel. The microheater is an electrical resistor that is configured to provide heat to the hydrocarbon sample held in the sample reservoir. The hydrocarbon sample fractionates into the hydrocarbons, which are distributed across the component reservoirs, as the hydrocarbon sample flows from the sample reservoir to the outlet in response to receiving the heat from the microheater.

### TECHNICAL FIELD

This disclosure relates to distillation.

### BACKGROUND

Distillation is the process of separating components of a liquid mixture by using selective boiling and condensation. Distillation is commonly used in the oil and gas industry to fractionate crude oil into various useful products, such as gasoline, diesel, and kerosene. Industrial distillation is typically performed in large, vertical cylindrical columns known as distillation towers or distillation columns. The products with lower boiling points exit from the top of such columns, while the products with higher boiling points exit from the bottom of such columns.

### SUMMARY

This disclosure describes technologies relating to distillation of hydrocarbon samples. Certain aspects of the subject matter described can be implemented as an apparatus. The apparatus includes a plate and a microheater that is coupled to the plate. The plate defines a sample reservoir, component reservoirs, an outlet, a microfluidic channel, and branches. The sample reservoir is configured to hold a specified sample volume of a hydrocarbon sample. The hydrocarbon sample includes hydrocarbons. Each of the component reservoirs are configured to hold a respective specified component volume of a different one of the hydrocarbons. The microfluidic channel extends from the sample reservoir to the outlet. Each of the branches connect a different one of the component reservoirs to the microfluidic channel. The branches are distributed along a length of the microfluidic channel between the sample reservoir and the outlet. The microheater is an electrical resistor that is configured to provide heat to the hydrocarbon sample held in the sample reservoir. The electrical resistor is configured to provide the heat in response to receiving electrical power. The hydrocarbon sample fractionates into the hydrocarbons, which are distributed across the component reservoirs, as the hydrocarbon sample flows from the sample reservoir to the outlet in response to receiving the heat from the microheater.

This, and other aspects, can include one or more of the following features. The microheater can be configured to provide heat to the hydrocarbon sample, such that the hydrocarbon sample in the sample reservoir is maintained at an operating temperature in a range of from about 50 degrees Celsius (° C.) to about 400° C. The microheater can include platinum. The microheater can include ceramic. The microheater can have a thickness in a range of from about 150 nanometers (nm) to about 250 nm. The plate can have a maximum dimension of about 6 inches. The microfluidic channel can have a cross-sectional area that is perpendicular to a general direction of fluid flow of the hydrocarbon sample flowing through the microfluidic channel from the sample reservoir to the outlet. The cross-sectional area of the microfluidic channel can have a width in a range of from about 100 micrometers to about 5 millimeters. The cross-sectional area of the microfluidic channel can have a height in a range of from about 10 micrometers to about 500 micrometers. The microfluidic channel can have a shape of a meandering pathway. The components reservoirs can include a first component reservoir, a second component reservoir, and a third component reservoir. The branches can include a first branch, a second branch, and a third branch. The first branch can connect the first component reservoir to the microfluidic channel. The second branch can connect the second component reservoir to the microfluidic channel. The third branch can connect the third component reservoir to the microfluidic channel. A first distance between the sample reservoir and the first branch along the meandering pathway of the microfluidic channel can be in a range of from about 5 millimeters (mm) to about 10 cm. A second distance between the first branch and the second branch along the meandering pathway of the microfluidic channel can be in a range of from about 5 mm to about 10 cm. A third distance between the second branch and the third branch along the meandering pathway of the microfluidic channel can be in a range of from about 5 mm to about 10 cm.

Certain aspects of the subject matter described can be implemented as a method. A hydrocarbon sample is placed in a sample reservoir defined by a plate. The hydrocarbon sample includes hydrocarbons. Electrical power is supplied to a microheater coupled to the plate. The microheater is an electrical resistor. Heat is provided by the microheater to the hydrocarbon sample placed in the sample reservoir in response to receiving electrical power. In response to receiving heat from the microheater, the hydrocarbon sample is flowed from the sample reservoir through a microfluidic channel to an outlet. The plate defines the microfluidic channel, the outlet, component reservoirs, and branches. Each component reservoir is configured to hold a respective specified component volume of a different one of the hydrocarbons. Each branch connects a different one of the component reservoirs to the microfluidic channel. The branches are distributed along a length of the microfluidic channel between the sample reservoir and the outlet. The hydrocarbon sample fractionates into the hydrocarbons, which are distributed across the component reservoirs, as the hydrocarbon sample flows from the sample reservoir to the outlet.

This, and other aspects, can include one or more of the following features. Providing heat to the hydrocarbon sample placed in the sample reservoir can include maintaining the hydrocarbon sample in the sample reservoir at an operating temperature in a range of from about 50 degrees Celsius (° C.) to about 400° C. The microheater can include platinum. The microheater can include ceramic. The microheater can have a thickness in a range of from about 150 nanometers (nm) to about 250 nm. The plate can have a maximum dimension of about 6 inches. The microfluidic channel can have a cross-sectional area that is perpendicular to a general direction of fluid flow of the hydrocarbon sample flowing through the microfluidic channel from the sample reservoir to the outlet. The cross-sectional area of the microfluidic channel can have a width in a range of from about 100 micrometers to about 5 millimeters. The cross-sectional area of the microfluidic channel can have a height in a range of from about 10 micrometers to about 500 micrometers. The microfluidic channel can have a shape of a meandering pathway. The components reservoirs can include a first component reservoir, a second component reservoir, and a third component reservoir. The branches can include a first branch, a second branch, and a third branch. The first branch can connect the first component reservoir to the microfluidic channel. The second branch can connect the second component reservoir to the microfluidic channel. The third branch can connect the third component reservoir to the microfluidic channel. A first distance between the sample reservoir and the first branch along the meandering pathway of the microfluidic channel can be in a range of from about 5 millimeters (mm) to about 10 cm. A second distance between the first branch and the second branch along the meandering pathway of the microfluidic channel can be in a range of from about 5 mm to about 10 cm. A third distance between the second branch and the third branch along the meandering pathway of the microfluidic channel can be in a range of from about 5 mm to about 10 cm.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example apparatus for distilling hydrocarbons.

FIG. 2 is a flow chart of an example method for distilling hydrocarbons.

### DETAILED DESCRIPTION

This disclosure describes distillation of hydrocarbon samples to determine and quantify the hydrocarbon makeup of such hydrocarbon samples. An apparatus for hydrocarbon distillation includes a plate. The plate defines a sample reservoir, an outlet, and a microfluidic channel that extends from the sample reservoir and the outlet. The sample reservoir can hold a specified volume The plate defines multiple component reservoirs that each are configured to hold a respective specified component volume of a different hydrocarbon (depending on properties of the hydrocarbon, such as molecular weight and boiling point). The component reservoirs branch from the microfluidic channel. A microheater coupled to the plate provides heat to the hydrocarbon sample. Heating the hydrocarbon sample causes the hydrocarbon sample to flow from the sample reservoir through the microfluidic channel to the outlet. The hydrocarbon sample fractionates into the different hydrocarbons, which are distributed across the component reservoirs. The volumes of fluid remaining in the component reservoirs can be measured to determine the hydrocarbon makeup of the hydrocarbon sample.

The subject matter described in this disclosure can be implemented in particular implementations, so as to realize one or more of the following advantages. The composition (hydrocarbon makeup) of hydrocarbon samples can be determined without the need for laboratory characterization and complex analysis, such as gas chromatography, gas chromatography-mass spectrometry (GC-MS), or X-ray fluorescence (XRF) spectrometry, which typically require large and expensive laboratory setups. The apparatuses and methods described can be implemented to determine hydrocarbon makeup of hydrocarbon samples more quickly and at lower capital and/or operating costs in comparison to conventional methods. For example, the apparatuses and methods described require only small volumes (for example, about 3 to about 5 milliliters) of hydrocarbon samples for testing. For example, the apparatuses described are compact and do not have large volume requirements for hydrocarbon sample testing. For example, the apparatuses and methods described use small amounts of power (for example, less than 5 Watts) for hydrocarbon sample testing. The apparatuses and methods described can be implemented to quickly and simply identify the presence and/or determine a concentration of a hydrocarbon fuel (such as gasoline or diesel) in lubrication oils. As such, the apparatuses and methods described can be implemented to identify instances of hydrocarbon smuggling and can be used to prevent such illegal practices. As another example, the apparatuses and methods described can be implemented to identify instances and properties of oil leakage from a pipe.

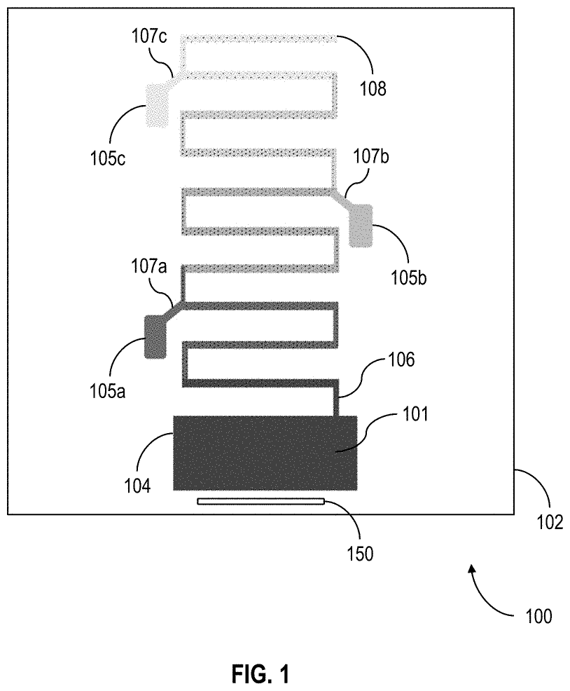

FIG. 1 depicts an example apparatus 100 that can be used to distill a hydrocarbon sample 101. The hydrocarbon sample 101 includes multiple hydrocarbons (that is, a mixture of hydrocarbons). For example, the hydrocarbon sample 101 is a lubrication oil. In some cases, the hydrocarbon sample 101 is a lubrication oil that includes a hydrocarbon fuel (such as gasoline and/or diesel). The hydrocarbon sample 101 can be fractionated into its various constituents using the apparatus 100. The apparatus 100 includes a plate 102 and a microheater 150. The plate 102 defines a sample reservoir 104, a microfluidic channel 106, and an outlet 108. The microfluidic channel 106 extends from the sample reservoir 104 to the outlet 108. The sample reservoir 104 is configured to hold an entire liquid volume of the hydrocarbon sample 101. In some implementations, the sample reservoir 104 is configured to hold a maximum liquid volume of about 20 milliliters (mL), about 15 mL, about 10 mL, about 8 mL, about 6 mL, or about 5 mL. In some implementations, the hydrocarbon sample 101 has a liquid volume in a range of from about 2 mL to about 10 mL, from about 3 mL to about 8 mL, or from about 3 mL to about 5 mL. The microheater 150 is located near the sample reservoir 104 and provides heat to the hydrocarbon sample 101 residing in the sample reservoir 104.

The plate 102 defines multiple component reservoirs, which are labelled with reference number 105 followed by a letter. For example, the apparatus 100 shown in FIG. 1 has three component reservoirs 105a, 105b, and 105c. Although shown in FIG. 1 as having three component reservoirs 105a, 105b, 105c, the apparatus 100 can include fewer component reservoirs (for example, one component reservoir 105a or two component reservoirs 105a, 105b) or more component reservoirs (for example, four component reservoirs or more than four component reservoirs). Each component reservoir 105 is configured to hold a respective specified component volume of a different one of the various constituents making up the hydrocarbon sample 101. For example, a first component reservoir 105a can be configured to hold a first specified component volume of diesel, a second component reservoir 105b can be configured to hold a second specified component volume of paraffin oils, a third component reservoir 105c can be configured to hold a third specified component volume of gasoline, and a fourth component reservoir (not shown) can be configured to hold a fourth specified component volume of naphtha. In operation, the first component reservoir 105a is located above the sample reservoir 104 with respect to gravity, and each following component reservoir is located above the preceding component reservoir—for example, component reservoir 105b is located above component reservoir 105a, and component reservoir 105c is located above component reservoir 105b. In operation, the outlet 108 is located above all of the component reservoirs 105 (and therefore also the sample reservoir 104).

The plate 102 defines multiple branches, which are labelled with reference number 107 followed by a letter. The branches 107 are distributed along a length of the microfluidic channel 106 between the sample reservoir 104 and the outlet 108. Each branch 107 connects a different one of the component reservoirs 105 to the microfluidic channel 106. Thus, there are the same number of branches 107 as there are component reservoirs 105. For example, the apparatus 100 shown in FIG. 1 has three branches 107a, 107b, and 107c. The first branch 107a connects the first component reservoir 105a to the microfluidic channel 106. The second branch 107b connects the second component reservoir 105b to the microfluidic channel 106. The third branch 107c connects the third component reservoir 105c to the microfluidic channel 106. Although shown in FIG. 1 as having three branches 107a, 107b, 107c, the apparatus 100 can include fewer branches (for example, one branch 107a or two branches 107a, 107b) or more branches (for example, four branches or more than four branches), depending on the number of component reservoirs 105. The sample reservoir 104, component reservoirs 105, microfluidic channel 106, branches 107, and outlet 108 can be formed on the plate 102 by any suitable method, such as by laser ablation, reactive ion etching, chemical etching, or mechanical engraving.

As the microheater 150 provides heat to the hydrocarbon sample 101, the hydrocarbon sample 101 begins to evaporate. The more volatile components (for example, with smaller molecular weight) of the hydrocarbon sample 101 evaporate more quickly than the heavier components (for example, with larger molecular weight) of the hydrocarbon sample 101. By nature of vapors tending to have less density than liquids, the vapor produced by evaporation of the hydrocarbon sample 101 will rise and travel through the microfluidic channel 106 toward the outlet 108. As the vapor rises, the vapor cools. In some cases, the vapor will re-condense and settle in one or more of the component reservoirs 105. The specific locations at which the vapor condenses as the vapor travels through the microfluidic channel 106 will depend on various factors, such as composition of the hydrocarbon sample 101, locations of the component reservoirs 105, lengths of the branches 107 between the component reservoirs, and operating temperature of the microheater 150.

The microheater 150 is coupled to the plate 102. The microheater 150 is a small powered heater that can provide heating with precise and accurate temperature control. The microheater 150 is or includes an electrical resistor that is configured to provide heat to the hydrocarbon sample 101 held in the sample reservoir 104 in response to receiving electrical power. The microheater converts electrical power into heat through the process of Joule heating. For example, an electric current through the microheater 150 encounters resistance, resulting in heating of the microheater 150. The heating of the microheater 150 is independent of the direction of the electric current. The amount of heat provided by the microheater 150 is proportional to the electrical power received by the microheater 150. The hydrocarbon sample 101 flows from the sample reservoir 104 through the microfluidic channel 106 to the outlet 108 in response to receiving heat from the microheater 150. The hydrocarbon sample 101 fractionates into its various constituents, which are distributed across the component reservoirs 105 as the hydrocarbon sample 101 flows from the sample reservoir 104 through the microfluidic channel 106 to the outlet 108. In some implementations, the microheater 150 is configured to provide heat to the hydrocarbon sample 101 in the sample reservoir 104, such that the hydrocarbon sample 101 in the sample reservoir 104 is maintained at an operating temperature that is in a range of from about 50 degrees Celsius (° C.) to about 400° C., from about 75° C. to about 400° C., from about 100° C. to about 400° C., from about 125° C. to about 400° C., from about 150° C. to about 400° C., from about 175° C. to about 400° C., from about 200° C. to about 400° C., from about 225° C. to about 400° C., from about 250° C. to about 400° C., from about 275° C. to about 400° C., from about 300° C. to about 400° C., from about 325° C. to about 400° C., from about 350° C. to about 400° C., from about 375° C. to about 400° C., from about 50° C. to about 350° C., from about 50° C. to about 250° C., from about 100° C. to about 300° C., from about 150° C. to about 350° C., from about 50° C. to about 150° C., from about 100° C. to about 200° C., from about 150° C. to about 250° C., from about 200° C. to about 300° C., or from about 250° C. to about 350° C. The microheater 150 requires a small amount of power to generate heat to reach the desired temperatures. In some implementations, the microheater 150 is configured to generate heat at the desired temperature in response to receiving less than 5 Watts (W) of power, for example, less than 4 W, less than 3 W, less than 2 W, or less than 1 W (for example, a few milliWatts).

In some implementations, the microheater 150 is made of a metal. The microheater 150 can be made of nickel, chromium, iron, aluminum, copper, platinum, tungsten, or an alloy including any combination of these. For example, the microheater 150 is made of nichrome (a mixture of nickel and chromium), an iron-chromium-aluminum alloy (such as Kanthal), or cupronickel.

In some implementations, the microheater 150 is made of ceramic. For example, the microheater 150 can be made of molybdenum disilicide, silicon carbide, silicon nitride, or a positive temperature coefficient ceramic (such as barium titanate composite or lead titanate composite). A ceramic having a positive temperature coefficient (PTC) can experience an increase in electrical resistance when their temperature is raised. In some implementations, the microheater 150 is made of a polymer. For example, the microheater 150 can be made of a PTC rubber (such as a silicone rubber). Silicone rubber is an elastomer that includes silicone containing silicon together with carbon, hydrogen, and oxygen. For example, PTC rubber can be made of polydimethylsiloxane (PDMS) loaded with carbon nanoparticles.

In some implementations, the microheater 150 is made of a composite material that includes a metal, ceramic, a polymer, or any combination of these. For example, the microheater 150 can be a coil of nichrome (NiCr) disposed in a metallic tube (for example, of copper or stainless steel) and insulated by a metal oxide powder (such as magnesium oxide powder). For example, the microheater 150 can be in the form of screen-printed metal-ceramic tracks deposited on ceramic insulated metal plates. For example, the microheater 150 can include a coiled wire threaded through one or more ceramic segments with or without a center rod. In some implementations, the microheater 150 includes an electrical resistor (made of metal, ceramic, a polymer, or a composite material including any combination of these) and a thermal isolation material. For example, the microheater 150 can include a spiral wire of platinum (electrical resistor) that has been sputtered on top of quartz (thermal isolation material) via a fabrication process, such as lithography, inkjet printing, or shadow mask. The microheater 150 can be coupled to the plate 102 by any suitable method, such as ionic bonding, oxygen plasma bonding, or through the use of solvents and adhesives.

The plate 102 is made of a material that is chemically stable (for example, inert) in the presence of the hydrocarbons from the hydrocarbon sample 101. The plate 102 is made of a material that is thermally stable (for example, does not degrade and/or melt) upon exposure of the heat from the microheater 150 and maximum operating temperature of the microheater 150. In some implementations, the plate 102 is made of a polymer, such as PDMS or poly(methyl methacrylate) (PMMA). In some implementations, the plate 102 is made of a crystalline mineral, such as quartz.

In some implementations, the microheater 150 has a thickness in a range of from about 150 nanometers (nm) to about 300 nm. In some implementations, the microheater 150 has a width in a range of from about 5 micrometers (μm) to about 100 μm. In some implementations, the microheater 150 has a spiral shape having an outer diameter that is about 1 centimeter (cm) or smaller. In some implementations, the plate 102 has a maximum dimension of about 20 cm. For example, the plate 102 can have a shape of a cylinder and have a diameter in a range of from about 5 cm to about 20 cm. For example, the plate 102 can have a shape of a rectangular prism and have a width in a range of from about 5 cm to about 20 cm, a length in a range of from about 1 cm to about 20 cm, and a height in a range of from about 5 cm to about 20 cm.

The microfluidic channel 106 has a cross-sectional area that is perpendicular to a general direction of fluid flow of the hydrocarbon sample 101 flowing through the microfluidic channel 106 from the sample reservoir 104 to the outlet 108. In some implementations, the cross-sectional area of the microfluidic channel 106 has a width in a range of from about 10 μm to 1 millimeter (mm). In some implementations, the cross-sectional area of the microfluidic channel 106 has a height in a range of from about 10 μm to about 500 μm. In some implementations, as shown in FIG. 1, the microfluidic channel 106 has a shape of a meandering pathway. In some implementations, a distance between neighboring (that is, consecutive) branches 107 (for example, between branches 107a and 107b or between branches 107b and 107c) is in a range of from about 5 mm to about 10 cm.

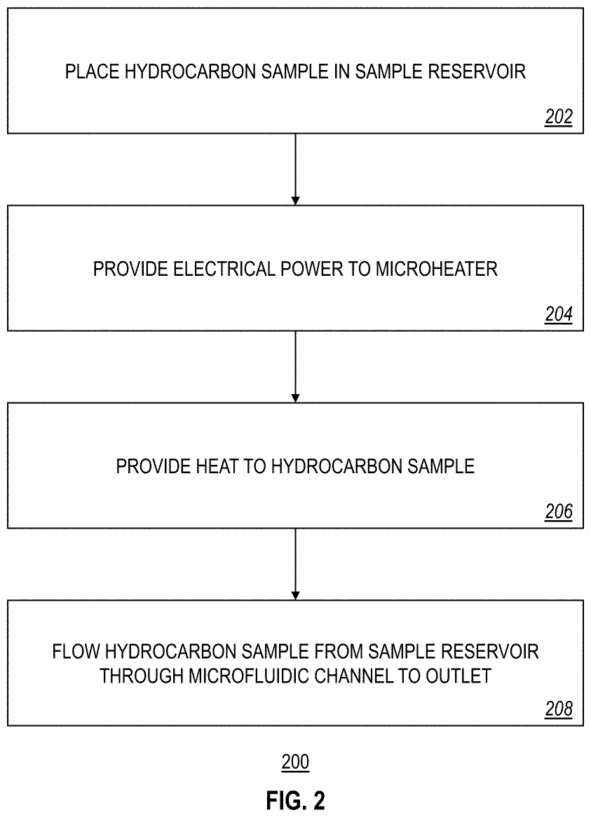

FIG. 2 is a flow chart of an example method 200 for hydrocarbon distillation. The apparatus 100 can, for example, be used to implement method 200. At block 202, a hydrocarbon sample (such as the hydrocarbon sample 101) is placed in a sample reservoir (such as the sample reservoir 104) defined by a plate (such as the plate 102). As mentioned previously, the hydrocarbon sample 101 includes various constituents (such as various hydrocarbons). At block 204, electrical power is provided to a microheater (such as the microheater 150) that is coupled to the plate 102. As mentioned previously, the microheater 150 can be an electrical resistor. At block 206, heat is provided by the microheater 150 to the hydrocarbon sample 101 (placed in the sample reservoir 104 at block 202) in response to receiving the electrical power at block 204. The amount of heat provided by the microheater 150 at block 206 is proportional to the electrical power received by the microheater 150 at block 204. In response to receiving heat from the microheater 150 at block 206, the hydrocarbon sample 101 flows from the sample reservoir 104 through a microfluidic channel (such as the microfluidic channel 106) to an outlet (such as the outlet 108) defined by the plate 102 at block 208. The plate 102 defines component reservoirs (such as the component reservoirs 105), and each component reservoir 105 is configured to hold a respective specified component volume of a different one of the various constituents that makeup the hydrocarbon sample 101. The plate 102 defines branches (such as the branches 107) that connect the component reservoirs 105 to the microfluidic channel 106. As the hydrocarbon sample 101 flows from the sample reservoir 104 through the microfluidic channel 106 to the outlet 108 at block 208, the hydrocarbon sample 101 fractionates into the various constituents, which are distributed across the component reservoirs 105. Once the hydrocarbon sample 101 has fractionated into its various constituents, and its constituents have distributed across the component reservoirs 105, the component reservoirs 105 can be evaluated to determine the volumes of fluid remaining in each of the component reservoirs 105. Image data of the component reservoirs 105 can, for example, be obtained using a camera, and the image data can be analyzed to determine the volumes of fluid remaining in each of the component reservoirs 105. In some implementations, the component reservoirs 105 are labelled with volume tick marks that indicate specified volumes (for example, like a graduated cylinder). For example, the volume tick marks can be for specified volumes on the order of microliters or milliliters.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. An apparatus comprising:
a plate defining:
a sample reservoir configured to hold a specified sample volume of a hydrocarbon sample comprising a plurality of hydrocarbons;
a plurality of component reservoirs, each of the plurality of component reservoirs configured to hold a respective specified component volume of a different one of the plurality of hydrocarbons;
an outlet;
a microfluidic channel extending from the sample reservoir to the outlet; and
a plurality of branches, wherein each of the plurality of branches connect a different one of the plurality of component reservoirs to the microfluidic channel, wherein the plurality of branches are distributed along a length of the microfluidic channel between the sample reservoir and the outlet; and
a microheater coupled to the plate, wherein the microheater is an electrical resistor configured to provide heat to the hydrocarbon sample held in the sample reservoir in response to receiving electrical power, wherein the hydrocarbon sample fractionates into the plurality of hydrocarbons, which are distributed across the plurality of component reservoirs, as the hydrocarbon sample flows from the sample reservoir to the outlet in response to receiving the heat from the microheater.

2. The apparatus of claim 1, wherein the microheater is configured to provide heat to the hydrocarbon sample, such that the hydrocarbon sample in the sample reservoir is maintained at an operating temperature in a range of from about 50 degrees Celsius (° C.) to about 400° C.

3. The apparatus of claim 2, wherein the microheater comprises platinum.

4. The apparatus of claim 2, wherein the microheater comprises ceramic.

5. The apparatus of claim 2, wherein the microheater has a thickness in a range of from about 150 nanometers (nm) to about 250 nm.

6. The apparatus of claim 2, wherein the plate has a maximum dimension of about 6 inches.

7. The apparatus of claim 6, wherein the microfluidic channel has a cross-sectional area that is perpendicular to a general direction of fluid flow of the hydrocarbon sample flowing through the microfluidic channel from the sample reservoir to the outlet, and the cross-sectional area has a width in a range of from about 100 micrometers to about 5 millimeters.

8. The apparatus of claim 7, wherein the cross-sectional area of the microfluidic channel has a height in a range of from about 10 micrometers to about 500 micrometers.

9. The apparatus of claim 8, wherein the microfluidic channel has a shape of a meandering pathway.

10. The apparatus of claim 9, wherein:
the plurality of component reservoirs comprises a first component reservoir, a second component reservoir, and a third component reservoir;
the plurality of branches comprises a first branch, a second branch, and a third branch;
the first branch connects the first component reservoir to the microfluidic channel;
the second branch connects the second component reservoir to the microfluidic channel;
the third branch connects the third component reservoir to the microfluidic channel;
a first distance between the sample reservoir and the first branch along the meandering pathway of the microfluidic channel is in a range of from about 5 millimeters (mm) to about 10 centimeters (cm);
a second distance between the first branch and the second branch along the meandering pathway of the microfluidic channel is in a range of from about 5 mm to about 10 cm; and
a third distance between the second branch and the third branch along the meandering pathway of the microfluidic channel is in a range of from about 5 mm to about 10 cm.

11. A method comprising:
placing a hydrocarbon sample in a sample reservoir defined by a plate, the hydrocarbon sample comprising a plurality of hydrocarbons;
providing electrical power to a microheater coupled to the plate, wherein the microheater is an electrical resistor;
providing, by the microheater, heat to the hydrocarbon sample placed in the sample reservoir in response to receiving electrical power; and
in response to receiving heat from the microheater, flowing the hydrocarbon sample from the sample reservoir through a microfluidic channel to an outlet defined by the plate, wherein:
the plate defines a plurality of component reservoirs, each component reservoir configured to hold a respective specified component volume of a different one of the plurality of hydrocarbons,
the plate defines a plurality of branches, each branch connecting a different one of the plurality of component reservoirs to the microfluidic channel, the plurality of branches distributed along a length of the microfluidic channel between the sample reservoir and the outlet, and
the hydrocarbon sample fractionates into the plurality of hydrocarbons, which are distributed across the plurality of component reservoirs, as the hydrocarbon sample flows from the sample reservoir to the outlet.

12. The method of claim 11, wherein providing heat to the hydrocarbon sample placed in the sample reservoir comprises maintaining the hydrocarbon sample in the sample reservoir at an operating temperature in a range of from about 50 degrees Celsius (° C.) to about 400° C.

13. The method of claim 12, wherein the microheater comprises platinum.

14. The method of claim 12, wherein the microheater comprises ceramic.

15. The method of claim 12, wherein the microheater has a thickness in a range of from about 150 nanometers (nm) to about 250 nm.

16. The method of claim 12, wherein the plate has a maximum dimension of about 6 inches.

17. The method of claim 16, wherein the microfluidic channel has a cross-sectional area that is perpendicular to a general direction of fluid flow of the hydrocarbon sample flowing through the microfluidic channel from the sample reservoir to the outlet, and the cross-sectional area has a width in a range of from about 100 micrometers to about 5 millimeters.

18. The method of claim 17, wherein the cross-sectional area of the microfluidic channel has a height in a range of from about 10 micrometers to about 500 micrometers.

19. The method of claim 18, wherein the microfluidic channel has a shape of a meandering pathway.

20. The method of claim 19, wherein:
the plurality of component reservoirs comprises a first component reservoir, a second component reservoir, and a third component reservoir;
the plurality of branches comprises a first branch, a second branch, and a third branch;
the first branch connects the first component reservoir to the microfluidic channel;
the second branch connects the second component reservoir to the microfluidic channel;
the third branch connects the third component reservoir to the microfluidic channel;
a first distance between the sample reservoir and the first branch along the meandering pathway of the microfluidic channel is in a range of from about 5 millimeters (mm) to about 10 centimeters (cm);
a second distance between the first branch and the second branch along the meandering pathway of the microfluidic channel is in a range of from about 5 mm to about 10 cm; and
a third distance between the second branch and the third branch along the meandering pathway of the microfluidic channel is in a range of from about 5 mm to about 10 cm.
